(19) United States
(12) Patent Application Publication
(10) Pub. No.: US 2021/0138350 A1
(43) Pub. Date: May 13, 2021

(54) SENSOR STATISTICS FOR RANKING USERS IN MATCHMAKING SYSTEMS

(71) Applicant: QUALCOMM Incorporated, San Diego, CA (US)

(72) Inventors: Diyan Teng, Santa Clara, CA (US); Mehul Soman, Sunnyvale, CA (US); Shashank Narayanan, Sunnyvale, CA (US)

(21) Appl. No.: 16/680,642

(22) Filed: Nov. 12, 2019

(51) Int. Cl. A63F 13/795; G06N 20/00; G06N 5/04; A63F 13/67

(52) U.S. Cl. CPC A63F 13/795; A63F 13/67; G06N 5/04; G06N 20/00

(57) ABSTRACT

Methods, systems, and devices for game matchmaking are described. The methods, systems, and devices for game matchmaking may include determining a ranking of a first user of a set of users in a game environment, monitoring, via a sensor, a performance attribute of the first user while the first user plays a game in the game environment, modifying the ranking of the first user in the game environment based on the monitored performance attribute of the first user, and, in some examples, matching the first user with a second user of the set of users based on the modified ranking of the first user.

### BACKGROUND

The use of computer systems and computer-related technologies continues to increase at a rapid pace. The expansive use of computer systems has influenced the advances made to computer-related technologies, such as online gaming. Computer systems have increasingly become an integral part of the business world and the activities of individual consumers. Computer systems may be used to carry out several business, industry, and academic endeavors.

The use of computers and mobile devices has caused an increased presence in online gaming and gaming tournaments. However, online gaming may match users with varying skill levels, which can give one player an unfair advantage over the other.

### SUMMARY

The described techniques relate to improved methods, systems, devices, and apparatuses that support sensor statistics for ranking users in matchmaking systems. Generally, the described techniques provide for improving the accuracy and fairness of game matchmaking systems related to online gaming. The described techniques may include determining a ranking of a first user among multiple users in a game environment based on analysis of data, such as real-time analysis of sensor data. The real-time analysis may include monitoring, via a sensor, a performance attribute of the first user while the first user plays a game in the game environment. In some cases, the real-time analysis may include modifying the ranking of the first user in the game environment based on the monitored performance attribute of the first user. In some examples, methods may include matching the first user with a second user from the multiple users based on the modified ranking of the first user.

A method of game matchmaking is described. The method may include determining a ranking of a first user of a set of users in a game environment, monitoring, via a sensor, a performance attribute of the first user while the first user plays a game in the game environment, modifying the ranking of the first user in the game environment based on the monitored performance attribute of the first user, and matching the first user with a second user of the set of users based on the modified ranking of the first user.

An apparatus for game matchmaking is described. The apparatus may include a processor, memory coupled with the processor, and instructions stored in the memory. The instructions may be executable by the processor to cause the apparatus to determine a ranking of a first user of a set of users in a game environment, monitor, via a sensor, a performance attribute of the first user while the first user plays a game in the game environment, modify the ranking of the first user in the game environment based on the monitored performance attribute of the first user, and match the first user with a second user of the set of users based on the modified ranking of the first user.

Another apparatus for game matchmaking is described. The apparatus may include means for determining a ranking of a first user of a set of users in a game environment, monitoring, via a sensor, a performance attribute of the first user while the first user plays a game in the game environment, modifying the ranking of the first user in the game environment based on the monitored performance attribute of the first user, and matching the first user with a second user of the set of users based on the modified ranking of the first user.

A non-transitory computer-readable medium storing code for game matchmaking is described. The code may include instructions executable by a processor to determine a ranking of a first user of a set of users in a game environment, monitor, via a sensor, a performance attribute of the first user while the first user plays a game in the game environment, modify the ranking of the first user in the game environment based on the monitored performance attribute of the first user, and match the first user with a second user of the set of users based on the modified ranking of the first user.

Some examples of the method, apparatuses, and non-transitory computer-readable medium described herein may further include operations, features, means, or instructions for modifying the ranking of the first user in the game environment based on a previous performance attribute of the first user during a previous game.

Some examples of the method, apparatuses, and non-transitory computer-readable medium described herein may further include operations, features, means, or instructions for comparing the performance attribute of the first user to a performance attribute threshold, where modifying the ranking of the first user may be based on a result of comparing the performance attribute of the first user to the performance attribute threshold.

Some examples of the method, apparatuses, and non-transitory computer-readable medium described herein may further include operations, features, means, or instructions for analyzing the performance attribute of the first user using machine learning, where modifying the ranking of the first user may be based at least in part on a result of analyzing the performance attribute of the first user using machine learning.

In some examples of the method, apparatuses, and non-transitory computer-readable medium described herein, analyzing the performance attribute of the first user using machine learning may include operations, features, means, or instructions for analyzing a match history of the first user using machine learning, the match history including at least one previous match outcome associated with the first user linked with the monitored performance attribute of the first user.

Some examples of the method, apparatuses, and non-transitory computer-readable medium described herein may further include operations, features, means, or instructions for predicting an outcome of a match between the first user and the second user based on a result of analyzing the performance attribute of the first user using machine learning.

In some examples of the method, apparatuses, and non-transitory computer-readable medium described herein, the performance attribute includes an inertial measurement unit, or an eye movement, or a heart rate, or a controller movement, or a rate of movement, or any combination thereof.

In some examples of the method, apparatuses, and non-transitory computer-readable medium described herein, the sensor includes an eye tracker, or a heart monitor, or a gyroscope, or a motion sensor, or an infrared sensor, or a biometric sensor, or any combination thereof.

In some examples of the method, apparatuses, and non-transitory computer-readable medium described herein, the sensor may be integrated in a smart phone, a game controller, a remote control, a television, a game console, a camera, or any combination thereof.

### BRIEF DESCRIPTION OF THE DRAWINGS

FIG. 1 illustrates an example of a system for game matchmaking that supports using sensor statistics for ranking users in matchmaking systems in accordance with aspects of the present disclosure.

FIG. 2 illustrates an example of a system for game matchmaking that supports using sensor statistics for ranking users in matchmaking systems in accordance with aspects of the present disclosure.

FIG. 3 illustrates an example of a process flow that supports using sensor statistics for ranking users in matchmaking systems in accordance with aspects of the present disclosure.

FIGS. 4 and 5 show block diagrams of devices that support sensor statistics for ranking users in matchmaking systems in accordance with aspects of the present disclosure.

FIG. 6 shows a block diagram of a matchmaking manager that supports using sensor statistics for ranking users in matchmaking systems in accordance with aspects of the present disclosure.

FIG. 7 shows a diagram of a system including a device that supports using sensor statistics for ranking users in matchmaking systems in accordance with aspects of the present disclosure.

FIGS. 8 and 9 show flowcharts illustrating methods that support sensor statistics for ranking users in matchmaking systems in accordance with aspects of the present disclosure.

### DETAILED DESCRIPTION

The described techniques relate to improved methods, systems, or devices that support game matchmaking. Other matchmaking systems for online gaming are limited to considering software-based statistics and are relatively slow and inaccurate in reflecting user skill level (i.e., processing many matches, such as hundreds of matches, in order to reach an accurate assessment of user skills), which results in unfair game matchmaking, such as unfairly penalizing losing teams or unfairly awarding winning teams without consideration of user skill levels based on more accurate and relevant sensor statistics (e.g., monitored data provided by sensors measuring user actions and user conditions before, during, or after game play), resulting in matching a first user with a relatively high skill level (e.g., an expert skill level) against a second user with a relatively low skill level (e.g., a beginner skill level). The described techniques improve other matchmaking systems by using sensor statistics to measure how users are playing a game in real-time.

The described techniques may include analyzing sensor data to measure how users interact with peripheral and input devices (e.g., mouse, keyboard, joystick, virtual reality headset, display, touchscreen, headphones, microphone, etc.) and use the resulting sensor statistics to determine a more accurate user skill level, and rank users from a group of users based on the more accurate user skill levels. In some cases, a peripheral device may include one or more of the monitored sensors integrated in peripheral devices or controllers (e.g., smartphones, joysticks), or in both. In some cases, one or more of the monitored sensors may be external to a peripheral device (e.g., camera, fingerprint sensor, motion tracking device, microphone, etc.).

In some examples, examples of the monitored sensors may include at least one of an inertial measurement units (IMUs), or eye trackers, or heart rate sensors, or any combination thereof. In some cases, an IMU may include at least one of accelerometers, or gyroscopes, or magnetometers, or any combination thereof. By supplementing other matchmaking and ranking systems with real-time sensor information, real-time skill level corrections and adjustments, and related ranking information will improve the other matchmaking and ranking systems by providing faster ranking determinations and more accurate rankings that result in users with equivalent skill levels being matched together.

In some cases, the methods, systems, or devices described herein may support the monitoring, analysis, and implementation of game matchmaking. The described techniques may be effective in matching a first user from a group of users to a second user from the group of users. In some examples, the first user may be matched with the second user based on monitoring feedback associated with the first user interacting with a first peripheral or input device (e.g., sensor statistics from a mouse, keyboard, joystick, touch screen, etc.). In some cases, the first player and the second player may both be human players. In some cases, the second player may be a computerized player (e.g., artificial intelligence player or simulated player). In some cases, the computerized version of the second player may be based on an ideal simulation reference model. In some cases, the first player may be matched with the second player that is based on the ideal simulation reference model in order to analyze the performance of the first user. In some cases, the ranking of the first user may be updated based on the analyzed performance.

Additionally or alternatively, the first user may be matched with the second user based on monitoring feedback associated with the second user interacting with the first peripheral device or the second user interacting with a second peripheral device different from the first peripheral device. The monitored feedback may enable the detection of user behaviors (e.g., user eye movement relative to a display of a computing device, finger movement relative to a peripheral device of a computing device, rate of finger movement, complexity of finger movement, user breathing rate, user breathing patterns, user heartrate, etc.). This monitoring and analysis may enable determination of a user skill level and game matchmaking between two or more users based on a determination of corresponding or relatively equivalent user skill levels of the matched users.

Aspects of the disclosure are initially described in the context of game matchmaking systems. Aspects of the disclosure are further illustrated by and described with reference to a process flow. Aspects of the disclosure are further illustrated by and described with reference to apparatus diagrams, system diagrams, and flowcharts that relate to sensor statistics for ranking users in matchmaking systems.

FIG. 1 illustrates an example of an environment 100 that supports game matchmaking in accordance with aspects of the present disclosure. As depicted, the environment 100 may include a computing device 105-a, a computing device 105-b, a computing device 105-c, a server 120, and a database 125. The techniques described herein may be performed on a device (e.g., a computing device 105 or the server 120, or both). In the illustrated example, the computing devices 105, the server 120, and the database 125, may be communicatively coupled via a network 130 (e.g., via communication links 155). As illustrated, at least one of computing devices 105 may include a peripheral 165. As shown, at least one of the peripherals 165 may include a sensor 170. Examples of sensor 170 include at least one of accelerometers, or dynamometers, or potentiometers, or gyroscopes, or pressure sensors, or motion sensors, or proximity sensors, or compass sensors, or fingerprint sensors, or temperature sensors, or image sensors, or audio sensors, or shock sensors, or proximity sensors, or boundary sensors, or light beam sensors, or three-dimensional (3-D) sensors, or global positioning system (GPS) sensors, or local positioning system (LPS) sensors, or Wi-Fi positioning system sensors, or capacitance sensors, or radio frequency sensors, or near-field sensors, or heartbeat sensors, or breathing sensors, or oxygen sensors, or carbon dioxide sensors, or brain wave sensors, or movement sensors, or voice sensor, or any combinations thereof.

The computing devices 105 in the environment 100 may be used by way of example. While the environment 100 illustrates three computing devices 105, the present disclosure applies to any system architecture having one or more computing devices 105. Further, while a single network is coupled to the computing devices 105, the server 120, and the database 125, the present disclosure applies to any system architecture having any number of networks that may be communicatively coupled to the computing devices 105, the server 120, and the database 125. Similarly, while the environment 100 illustrates a single server, the present disclosure applies to any system architecture having one or more servers.

In some examples, the computing devices 105, the server 120, and the database 125 may include a personal electronic device such as a cellular phone, a personal digital assistant (PDA), a tablet computer, a laptop computer, a desktop computer, a gaming console, or a gaming server. In some examples, the computing devices 105 may have one or more applications installed (e.g., one or more gaming applications). For example, the computing device 105-a may include an application 110-a, the computing device 105-b may include an application 110-b, and the computing device 105-c may include an application 110-c. The applications 110 may be the same software application (e.g., gaming application) or different software applications that are downloaded or installed (or both) on the computing devices 105. In some cases, at least one of applications 110 may be executing on at least one of computing devices 105. In some other examples, the computing devices 105 may have one or more additional applications installed (e.g., additional gaming applications). In some examples, at least one of computing device 105-a, computing device 105-b, or computing device 105-c may include a matchmaking manager 115. While the environment 100 illustrates the computing devices 105 each including a matchmaking manager 115, the present disclosure applies to any of the computing devices 105 (e.g., at least one) optionally having a matchmaking manager.

In some examples, the computing devices 105, the server 120, or both may include a matchmaking manager 115 where at least a portion of the functions of the matchmaking manager 115 are performed separately or concurrently on the computing devices 105 or the server 120, or both. Similarly, in some cases, a person may access the functions of the computing devices 105 (directly or through the computing device 105 via matchmaking manager 115). For example, the computing devices 105 may include a mobile-based application that interfaces with one or more functions of the matchmaking managers 115 or the server 120.

It is noted that in some cases, the computing devices 105, the server 120, or both may not include a matchmaking manager 115. For example, computing device 105-a may include application 110-a that enables computing device 105-a to interface with a matchmaking manager 115 that may be located on another computing device or the server 120. Although the components of the computing devices 105 are depicted as being internal to the computing device 105, it is understood that one or more of the components may be external to the computing devices 105 and connect to the computing devices 105 through wired or wireless connections, or both (e.g., via the communication links 155).

The server 120 may be a computing system or an application that may be an intermediary node in the environment 100 between the computing devices 105, or the database 125. The server 120 may include at least one of a gaming server, or a social network server, or a data server, or a cloud server, or a proxy server, or a mail server, or a web server, or an application server, or a database server, or a communications server, or a file server, or a home server, or a mobile server, or a name server, or any combination thereof. In some cases, the server 120 may include an application distribution platform. In some examples, the server 120 may include a matchmaking manager 115-d.

In some examples, database 125 may store user rankings, match data, and other information corresponding to applications 110. In some cases, the server 120 may receive a request from one or more of the computing devices 105 seeking resources from the server 120 or the database 125, or both (e.g., a request to download an application from server 120 or database 125, a request to download match data or user ranking data from server 120 or database 125, etc.). In some cases, the computing devices 105 may communicate with the server 120 via the network 130. Examples of the network 130 may include any combination of online gaming networks, cloud networks, local area networks (LAN), wide area networks (WAN), virtual private networks (VPN), wireless networks (using 802.11, for example), cellular networks (using third generation (3G), fourth generation (4G) (e.g., Long-Term Evolution (LTE)), or fifth generation (5G) new radio (NR) systems, for example), etc. In some examples, network 130 may include the Internet. In some examples, the server 120 may be coupled to the database 125, via a communication link 160. The communication link 160 may be a wired connection or a wireless connection.

In some examples, the computing device 105-a may run the application 110-a. The computing device 105-a may also implement one or more functions of the matchmaking manager 115-a. For example, the computing device 105-a may utilize the matchmaking manager 115-a to monitor the application 110-a or peripheral 165-a, or both, for match data and sensor statistics from sensor 170-a. In some examples, match data from computing device 105-a may include monitored user actions, real-time game play data, post-match game play data, sensor data from sensors 170-a user interactions with the application 110-a, and user interactions with the peripheral 165-a. For example, the computing device 105-a may monitor the application 110-a for game play statistics such as user scores, rate of points earned in a given time period, a length or time period of a match, etc. Similarly, computing device 105-a may monitor peripheral 165-a for sensor statistics from sensor 170-a such user eye movement relative to a display of a computing device, finger movement relative to peripheral 165-a, rate of finger movement, complexity of finger movement, user breathing rate, user breathing patterns, user heartrate, etc.

In some examples, computing device 105-a or server 120, or both, may be configured to monitor, via sensor 170-a, a performance attribute of a first user (e.g., from a group of users) while the first user operates peripheral 165- and interacts with application 110-a. In some cases, computing device 105-a or server 120, or both, may evaluate or analyze a result of the monitoring. In some examples, computing device 105-a or server 120, or both, may compare a monitored performance attribute to a determined ideal value for the monitored performance attribute.

In some cases, computing device 105-a or server 120, or both, may modify the ranking of the first user in a game environment based on a previous performance attribute of the first user during a previous monitoring operation. Examples of performance attributes may include a game score, a match outcome, a monitored performance (e.g., eye movement relative to a display of computing device 105-a, finger movement relative to peripheral 165-a, rate of finger movement, complexity of finger movement, user breathing rate, user breathing patterns, user heartrate, etc.). In some cases, computing device 105-a or server 120, or both, may match the first user with a second user from the group of users based on the modified ranking of the first user.

In some examples, a computing device 105, the server 120, or both may build one or more ideal behavior for applications 110 (e.g., ideal interaction between a user and a peripheral 165, or between a user and an application 110, or between a user and a peripheral 165 and an application 110). For example, the server 120 (e.g., using the matchmaking manager 115-d) may monitor the behaviors of the users interacting with applications 110 or peripherals 165, or both, on one or more computing devices (e.g., including at least one of computing device 105-a, computing device 105-b, or computing device 105-c).

In some cases, server 120 may determine an ideal behavior interaction with application 110 or peripheral 165, or both, based on the monitoring of the behaviors of the users interacting with applications 110 or peripherals 165, or both. In some cases, server 120 (e.g., via matchmaking manager 115-a) may use physics simulators to determine an ideal behavior with application 110 or peripheral 165, or both. In some cases, server 120 (e.g., via matchmaking manager 115-a) may associate behaviors of users of a given skill level interacting with application 110 or peripheral 165, or both, to determine an ideal behavior with application 110 or peripheral 165, or both, for the given skill level.

As described herein, computing devices 105 and server 120 may realize one or more of the following potential advantages. The computing devices 105 and server 120 may support improvements in game matchmaking, among other advantages. For example, computing devices 105 and server 120 may promote enhanced user ranking, real-time monitoring, and matchmaking between users of equivalent skill levels. Further, computing devices 105 and server 120, in conjunction with at least one matchmaking manager, may support real-time score calibration during a match.

Also, computing devices 105 and server 120, in conjunction with at least one matchmaking manager, may support reducing the time it takes to converge between two players of equivalent skill levels, improving the efficiency of matchmaking systems and avoiding matches between players with mismatched skill levels that unfairly penalize beginner players and unfairly award expert players. Thereby, the techniques described herein may provide improvements to the operation of computing devices 105 and server 120, for example, such as an improved user-experience based on more accurate game matchmaking.

FIG. 2 illustrates an example of a matchmaking system 200 that supports game matchmaking in accordance with aspects of the present disclosure. As depicted, the matchmaking system 200 may include multiple devices 205, device 210, and database 225. As shown, the multiple devices 205 may include device 205-a, device 205-b, device 205-c, device 205-d, and device 205-e. In some cases, at least some of devices 205 may be examples of computing devices 105 from FIG. 1. As shown, device 210 may include server 255, which may be an example of server 120 of FIG. 1. In some cases, device 210 or components of device 210 may be an example of or a component of server 120 or computing device 105, or a combination of both. In some cases, the matchmaking system 200 may include one or more processors, or one or more memory modules, or one or more storage devices, or any combination thereof.

As shown, device 205-a may be associated with user A, device 205-b may be associated with user B, device 205-c may be associated with user C, device 205-d may be associated with user D, and device 205-e may be associated with user E. In some cases, users such as user A, user B, user C, user D, or user E may be ranked at a particular skill level out of n skill levels. For example, a beginner user may be ranked at level 1, while an expert player may be ranked at level n. In the illustrated example, user A may be ranked at level n, user B may be ranked at level 1, user C may be ranked at level 1, user D may be ranked at level n, and user E may be ranked at level 1.

In some examples, device 210 may determine a ranking of a first user from a group of two or more users (e.g., users in a game environment). As shown, device 210 may receive or request information from database 225 such as match outcomes 230 or sensor statistics 235, or both. Examples of match outcomes 230 include user scores, a number of predefined accomplishments during a match, a rate of predefined accomplishments during a match, total points earned in a match, a rate of points earned within a given time period during a match, a length or time period of a match, etc. Examples of sensor statistics 235 include eye movement relative to a display of a device 205, finger movement relative to a peripheral of device 205, rate of finger movement, complexity of finger movement, user breathing rate, user breathing patterns, user heartrate, etc.

At 215, device 210 may process the information from database 225 in a machine learning algorithm. In some cases, device 210 may be configured to use machine learning to determine how users are controlling input devices and using sensor information (e.g., sensor statistics 235) to augment the determination of user skill ranking. In some cases, device 210 may use may process the information from database 225 in the machine learning algorithm of 215 to identify a correlation between sensor statistics 235 and match outcome 230. The data from database 225 may include information from past matches or ongoing matches, or both. In some cases, the machine learning algorithm of 215 may include a supervised learning framework that device 210 uses to calibrate player skill level based on match outcomes 230 and sensor statistics 235. Examples of the machine learning algorithm at 215 include linear regression, logistic regression, decision tree, support vector machine (SVM), naive Bayes, k-nearest neighbor, random forest, dimensionality reduction algorithms, gradient boosting algorithms, or any combination thereof.

In some examples, inputs to the machine learning algorithm of 215 may include match outcomes 230 or sensor statistics 235, or both, for one or more users (e.g., the first user from the group of users or the second user from the group of users, or both). In some cases, inputs to machine learning algorithm may include match outcomes 230 paired with sensor statistics 235. In some cases, inputs to the machine learning algorithm may include match outcomes 230 paired with sensor statistics 235 and one or more users. An output of the machine learning algorithm of 215 may include a predicted match outcome based on an input of at least sensors statistics 235. For example, the machine learning algorithm of 215 may include a model that predicts match outcomes based on inputs of at least match outcomes 230 or sensor statistics 235, or both. In one example, the machine learning algorithm of 215 may be trained to associate monitored sensor statistics (e.g., monitored in real-time) with match outcomes. For example, the machine learning algorithm of 215 may determine that a portion of a game that involves a precise operation. Examples of the precise operation may include at least one of moving a joystick with a particular precision and accuracy, or moving a mouse with a particular precision and accuracy, or moving a mouse with a particular precision and accuracy while clicking a button of the mouse, or pressing a combination of keys of the keyboard in a particular sequence such as A-D-W-S-W-D-D-A, or pressing the combination of keys of the keyboard within a particular time period, or any combination thereof. As one example, based on its training the machine learning algorithm of 215 may learn that it takes a player at level 1 (e.g., beginner level) one second (1000 milliseconds) or longer to finish pressing the combination of keys of the keyboard in the particular sequence, that a player at level 2 may press the combination of keys in the particular sequence within 800 to 900 milliseconds, that a player at level 3 may press the combination of keys in the particular sequence within 700 to 800 milliseconds, that a player at level 4 may press the combination of keys in the particular sequence within 600 to 700 milliseconds, that a player at level 5 may press the combination of keys in the particular sequence within 500 to 600 milliseconds, that a player at level n may press the combination of keys in the particular sequence under 200 milliseconds, and so forth. Accordingly, after being trained the machine learning algorithm may predict that a player being monitored (e.g., monitoring sensor statistics of the player in real-time) is likely a level 3 player because the monitoring and analysis of the combination of keys (e.g., among other monitored sensor statistics) indicate that the player presses the combination of keys within 700 to 800 milliseconds. Accordingly, the player may be ranked as a level 3 player based at least in part on the analysis of the sensor statistics associated with the machine learning algorithm.

As shown, an output of the machine learning algorithm of 215 may be included with user ranking parameters 220. For example, user ranking parameters of 220 may include at least one of match outcomes 230, or sensor statistics 235, or a predicted match outcome, or any combination thereof.

At 240, device 210 may feed one or more of the user ranking parameters of 220 associated with at least one user to a user ranking algorithm to determine a rank of a user. Accordingly, the device 210 may determine a user ranking based on an output of the user ranking algorithm at 240. In some cases, device 210 may receive match information from server 255. The match information may include a list of n levels from level 1 to level n. In some cases, the match information may include a list of users ranked at level 1, a list of users ranked at level n, and so forth. Accordingly, at 240, device 210 may feed one or more of the user ranking parameters of 220 associated with at least one user to a user ranking algorithm and match information from server 255 to determine a rank of a user.

At 245, device 210 may store a user ranking in a user rank database. In some cases, the user rank database may be included in database 225. Additionally or alternatively, the user rank database may be stored on another device such as server 255 or a device 205.

At 250, device 210 may pair user A with user D from the group of users based on the determined rank of user A and the determined rank of user D. As shown, a pairing of user A and user D may be sent to server 255. In some cases, server 255 may determine user A and user D are both ranked at level n. Accordingly, server 255 may generate a level n match between user A and user D. Similarly, server 255 may generate a level 1 match between user B and user C, or between user B and user E. or between user C and user E, or between user B, user C and user E.

During or after at least one match (e.g., at least one level 1 match, at least one level n match, etc.), server 255 may store the monitored match data from at least one match in match outcomes 230. In some cases, device 210 may use the updated match outcomes 230 to update the ranks of at least one of user A, user B, user C, user D, or user E, or any combination thereof.

In some examples, each user from the group of users may be given a default rank before a match is played. In some cases, a player ranking may be updated based on an outcome of a first match or a first set of matches. For example, user A, user B, user C, user D, and user E may be given a level 1 rank before any matches are played. After a first round of matches in which user A beats user D, and user E beats user C, user A and user E may be given a rank of level 2, while user D and user C may keep a rank of level 1. In some cases, user B may keep a rank of level 1 for not playing a match in the first round. In a second round, user D may beat user B, and user E may be user A. Accordingly, user E may be given a rank of level 3, user A may keep a level 2 rank, user D may be given a level 2 rank, user B may keep a level 1 rank, and user C may keep a rank of level 1 for not playing a match in the second round.

In some cases, sensor statistics (e.g., sensor data) may be monitored during the first or second round of matches, or both. In some cases, the sensor statistics may be stored in sensor statistics 235 for training the machine learning algorithm at 215. In some examples, device 210 may analyze the sensor statistics and determine ideal or predicted game-play behavior for each of the n rank levels based on the analysis. In some cases, device 210 may use the determined ideal or predicted game-play behavior to determine that the behavior of user A is equivalent to a level 3 rank player based on the monitored behavior of user A. Thus, even though user A loses to user E, based on the determined ideal game-play behavior, device 210 may adjust the ranking of user A to a level 3 rank equal to the rank of user E after an initial training based on the sensor statistics (e.g., sensor data) and related analysis. In some cases, device 210 may provide feedback to beginner players that includes performance charts personalized to a particular player, and tips on how to improve game play.

In some cases, device 210 may leverage the model learned by the machine learning algorithm at 215 to determine (e.g., map) a relationship between sensor statistics 235 and match outcomes 230. Accordingly, via a trained machine learning algorithm at 215, device 210 may monitor sensors in real-time to determine user behavior during a match and predict a match outcome based on the learned relationship between the analyzed sensor statistics 235 and match outcomes 230. In some cases, device 210 may use the learned relationship between the analyzed sensor statistics 235 and match outcomes 230 to determine a user ranking while monitoring a match or after monitoring the match.

The described techniques enable device 210 to use sensor information to measure how users are controlling peripherals and input devices, and then use this sensor information (e.g., sensor statistics 235) to augment the determination of user skill levels and user rankings. By supplementing the current ranking and matchmaking systems with real-time sensor information, the described techniques provide more accurate determination user skill levels and user rankings, and provide quicker corrections and adjustments to user skill levels and user rankings compared to other systems.

FIG. 3 illustrates an example of a process flow 300 that supports using sensor statistics for ranking users in matchmaking systems in accordance with aspects of the present disclosure. In some examples, process flow 300 may implement aspects of environment 100. In some examples, process flow 300 may implement aspects of matchmaking system 200. The computing device 105-a, peripheral 165-d, and server 120-a may be examples of corresponding devices described with reference to FIG. 1. In some examples, at least a portion of process flow 300 may be implemented by a matchmaking manager 115 in conjunction with at least one of computing device 105-d, or peripheral 165-, or server 120-a, or any combination thereof.

In the following description of the process flow 300, the operations between the computing device 105-a, the peripheral 165-d, and server 120-a may be transmitted in a different order than the exemplary order shown, or the operations performed by computing device 105-a, the peripheral 165-d, and server 120-a may be performed in different orders or at different times. Some operations may also be left out of the process flow 300, or other operations may be added to the process flow 300. Additionally, devices other than the computing device 105-a, the peripheral 165-d, or server 120-a may perform some of the operations described in the process flow 300.

At 305, server 120-a may match a first user to a second user. In some cases, the match may be based on a default initial ranking of the first user and the second user, or may be based on a determined and more accurate ranking of the first user and second user based on the techniques described herein. In some cases, server 120-a may send matchmaking data to computing device 105-a. In some cases, the matchmaking data may include the matching of the first user with the second user.

At 310, computing device 105-d may monitor an application (e.g., an application 110 of FIG. 1). For example, a user of computing device 105-d may execute the application and computing device 105-d may monitor the interaction between the user and the application at 310. In some cases, the application may include a game software application.

At 315, computing device 105-d may monitor a peripheral associated with computing device 105-d (e.g., a peripheral 165 of FIG. 1).

At 320, computing device 105-d may receive sensor data from the peripheral based on the monitoring of the peripheral at 315. In some cases, the sensor data may include sensor statistics (e.g., sensor statistics 235 of FIG. 2). The sensor statistics may include at least one of eye movement relative to a display of computing device 105-d, finger movement relative to peripheral 165-d, rate of finger movement relative to peripheral 165-d, complexity of finger movement relative to peripheral 165-d, frequency of operation relative to peripheral 165-d, periodicity relative to peripheral 165-d, spiky behavior relative to peripheral 165-d, eye concentration from an eye tracker associated with peripheral 165-d or computing device 105-d (or both), eye movement from the eye tracker associated with peripheral 165-d or computing device 105-d (or both), user breathing rate, user breathing patterns, user heartrate, heart rate variability (HRV), etc.

At 325, computing device 105-d may send match data to server 120-a. In some cases, the match data may include data associated with a match outcome (e.g., match outcomes 230 of FIG. 2). In some cases, the match data may include sensor data from 320. In some examples, match data 325 may include at least one of application data based on the monitoring of the application at 310, or peripheral data based on the monitoring of the peripheral at 315, or sensor data (e.g., the sensor data at 320), or match outcome data, or any combination thereof. Examples of match outcome data may include a winner of a match between the first user and the second user, a final score of the first user or the second user, a score differential, a time period of a match (e.g., how long a match lasts), a number of accomplishments during a match, etc.

In some cases, the match data at 325 may include real-time match data. For example, at least a portion of the match data may be sent before a match finishes (e.g., while the first user and the second user are playing a match). In some examples, computing device 105-d may collect match data while the first user and the second user are using the application (e.g., during a match between the first user and the second user). Thus, the ranking of the first user or the second user, or both, may be updated before the first user finishes a match with the second user. In some cases, the match data collected by computing device 105-d may be based on the monitoring of the application at 310, or the monitoring of the peripheral at 315, or the sensor data at 320, or any combination thereof.

At 330, server 120-a may analyze the match data received at 325. In some cases, server 120-a may use machine learning to analyze the match data (e.g., machine learning algorithm at 215 from FIG. 2).

At 335, server 120-a may update a ranking of the first user or the second user, or both, based on the analysis of the match data at 330.

At 340, server 120-a may match the first user to a third user based on the updated rank of the first user. For example, at 305 server 120-a may determine that the first user is at a level 3 ranking. Accordingly, at 305 server 120-a may match the first user with the second user, who is also at a level 3 ranking. However, after analyzing the match data at 330 from the match between the first user and the second user, server 120-a may determine the monitoring of the application at 310 and the monitoring of the peripheral at 315 indicates that the game play of first user has improved since the ranking of first user at 305 and that first user is now at a level 4 ranking. In some cases, server 120-a may determine that first user is a level 4 even if the first user loses to the second user. For example, the match data at 325 may include sensor statistics that, regardless of whether the first user wins or loses the match with the second user, that the first user is at a level 4 ranking. In some cases, when server 120-a determines that the first user is now at a level 4 ranking, but the first user loses to the second user, server 120-a may determine that the second user is also now at a level 4 ranking. However, even if the second user wins the match against the first user and the first user is ranked at a level 4 ranking, server 120-a may keep the second user as a level 3 rank if the sensor statistics of the second user indicate that the second user does not qualify for a level 4 ranking.

FIG. 4 shows a block diagram 400 of a device 405 that supports using sensor statistics for ranking users in matchmaking systems in accordance with aspects of the present disclosure. The device 405 may be an example of aspects of a device as described herein. The device 405 may include a sensor 410, a matchmaking manager 415, and memory 420. The device 405 may also include one or more processors. Each of these components may be in communication with one another (e.g., via one or more buses).

The sensor 410 may sense and provide information such as sensor data associated with user behavior and information related to sensor statistics for ranking users in matchmaking systems, etc. Information from sensor 410 may be passed on to other components of the device 405. The sensor 410 may be an example of aspects of the sensor 170 described with reference to FIG. 1. The sensor 410 may communicate over wired or wireless communication channels. The sensor 410 may utilize a single antenna or a set of antennas to communicate sensor data. Sensor 410 may include or be an example of a sensor for sensing user behavior associated with at least one of a computing device, or a peripheral, or an input device, or a display, or a touchsereen, or an application running on a computing device, or any combination thereof. Additionally or alternatively, components of device 405 used to communicate data over a wireless (e.g., or wired) link may be in communication with matchmaking manager 415 (e.g., via one or more buses) without passing information through sensor 410.

The matchmaking manager 415 may determine a ranking of a first user of a set of users in a game environment, modify the ranking of the first user in the game environment based on the monitored performance attribute of the first user, monitor, via a sensor, a performance attribute of the first user while the first user plays a game in the game environment, and match the first user with a second user of the set of users based on the modified ranking of the first user. The matchmaking manager 415 may be an example of aspects of the matchmaking manager 710 described herein.

The matchmaking manager 415, or its sub-components, may be implemented in hardware, code (e.g., software or firmware) executed by a processor, or any combination thereof. If implemented in code executed by a processor, the functions of the matchmaking manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The matchmaking manager 415, or its sub-components, may be physically located at various positions, including being distributed such that portions of functions are implemented at different physical locations by one or more physical components. In some examples, the matchmaking manager 415, or its sub-components, may be a separate and distinct component in accordance with various aspects of the present disclosure. In some examples, the matchmaking manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Memory 420 may store information (e.g., sensor information, sensor statistics, match outcomes, player rankings, user profiles, analysis data, etc.) generated by other components of the device such as matchmaking manager 415. For example, memory 420 may store sensor information with which to compare an output of matchmaking manager 415. Memory 420 may comprise one or more computer-readable storage media. Examples of memory 420 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., matchmaking manager 415).

FIG. 5 shows a block diagram 500 of a device 505 that supports using sensor statistics for ranking users in matchmaking systems in accordance with aspects of the present disclosure. The device 505 may be an example of aspects of a device 405 or a device 105 as described herein. The device 505 may include a sensor 510, a matchmaking manager 515, and a memory 535. The device 505 may also include a processor. Each of these components may be in communication with one another (e.g., via one or more buses).

The sensor 510 may sense and provide information such as sensor data associated with user behavior and information related to sensor statistics for ranking users in matchmaking systems, etc. Information from sensor 510 may be passed on to other components of the device 505. The sensor 510 may be an example of aspects of the sensor 170 described with reference to FIG. 1. The sensor 510 may communicate over wired or wireless communication channels. The sensor 510 may utilize a single antenna or a set of antennas to communicate sensor data. Sensor 510 may include or be an example of a sensor for sensing user behavior associated with at least one of a computing device, or a peripheral, or an input device, or a display, or a touchscreen, or an application running on a computing device, or any combination thereof. Additionally or alternatively, components of device 505 used to communicate data over a wireless (e.g., or wired) link may be in communication with matchmaking manager 515 (e.g., via one or more buses) without passing information through sensor 510.

The matchmaking manager 515 may be an example of aspects of the matchmaking manager 415 as described herein. The matchmaking manager 515 may include a ranking manager 520, a monitoring manager 525, and a matching manager 530. The matchmaking manager 515 may be an example of aspects of the matchmaking manager 710 described herein.

The ranking manager 520 may determine a ranking of a first user of a set of users in a game environment and modify the ranking of the first user in the game environment based on the monitored performance attribute of the first user. The monitoring manager 525 may monitor, via a sensor, a performance attribute of the first user while the first user plays a game in the game environment. The matching manager 530 may match the first user with a second user of the set of users based on the modified ranking of the first user.

Memory 535 may store information (e.g., sensor information, sensor statistics, match outcomes, player rankings, user profiles, analysis data, etc.) generated by other components of the device such as matchmaking manager 515. For example, memory 535 may store sensor information with which to compare an output of matchmaking manager 515. Memory 535 may comprise one or more computer-readable storage media. Examples of memory 535 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., matchmaking manager 515)

FIG. 6 shows a block diagram 600 of a matchmaking manager 605 that supports using sensor statistics for ranking users in matchmaking systems in accordance with aspects of the present disclosure. The matchmaking manager 605 may be an example of aspects of a matchmaking manager 415, a matchmaking manager 515, or a matchmaking manager 710 described herein. The matchmaking manager 605 may include a ranking manager 610, a monitoring manager 615, a matching manager 620, an analysis manager 625, and a prediction manager 630. Each of these modules may communicate, directly or indirectly, with one another (e.g., via one or more buses).

The ranking manager 610 may determine a ranking of a first user of a set of users in a game environment. In some examples, the ranking manager 610 may modify the ranking of the first user in the game environment based on the monitored performance attribute of the first user. In some examples, the ranking manager 610 may modify the ranking of the first user in the game environment based on a previous performance attribute of the first user during a previous game.

The monitoring manager 615 may monitor, via a sensor, a performance attribute of the first user while the first user plays a game in the game environment. In some cases, the performance attribute includes an inertial measurement unit, or an eye movement, or a heart rate, or a controller movement, or a rate of movement, or any combination thereof. In some cases, the sensor includes an eye tracker, or a heart monitor, or a gyroscope, or a motion sensor, or an infrared sensor, or a biometric sensor, or any combination thereof. In some cases, the sensor is integrated in a smart phone, a game controller, a remote control, a television, a game console, a camera, or any combination thereof.

The matching manager 620 may match the first user with a second user of the set of users based on the modified ranking of the first user.

The analysis manager 625 may compare the performance attribute of the first user to a performance attribute threshold, where modifying the ranking of the first user is based on a result of comparing the performance attribute of the first user to the performance attribute threshold. In some examples, the analysis manager 625 may analyze the performance attribute of the first user using machine learning, where modifying the ranking of the first user is based at least in part on a result of analyzing the performance attribute of the first user using machine learning. In some examples, the analysis manager 625 may analyze a match history of the first user using machine learning, the match history including at least one previous match outcome associated with the first user linked with the monitored performance attribute of the first user.

The prediction manager 630 may predict an outcome of a match between the first user and the second user based on a result of analyzing the performance attribute of the first user using machine learning.

FIG. 7 shows a diagram of a system 700 including a device 705 that supports using sensor statistics for ranking users in matchmaking systems in accordance with aspects of the present disclosure. The device 705 may be an example of or include the components of device 405, device 505, or a device as described herein. The device 705 may include components for bi-directional voice and data communications including components for transmitting and receiving communications, including a matchmaking manager 710, an I/O controller 715, a transceiver 720, an antenna 725, memory 730, a processor 740, and a coding manager 750. These components may be in electronic communication via one or more buses (e.g., bus 745).

The matchmaking manager 710 may determine a ranking of a first user of a set of users in a game environment, modify the ranking of the first user in the game environment based on the monitored performance attribute of the first user, monitor, via a sensor, a performance attribute of the first user while the first user plays a game in the game environment, and match the first user with a second user of the set of users based on the modified ranking of the first user.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described herein. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting sensor statistics for ranking users in matchmaking systems).

The code 735 may include instructions to implement aspects of the present disclosure, including instructions to support game matchmaking. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

FIG. 8 shows a flowchart illustrating a method 800 that supports using sensor statistics for ranking users in matchmaking systems in accordance with aspects of the present disclosure. The operations of method 800 may be implemented by a device or its components as described herein. For example, the operations of method 800 may be performed by a matchmaking manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 805, the device may determine a ranking of a first user of a set of users in a game environment. The operations of 805 may be performed according to the methods described herein. In some examples, aspects of the operations of 805 may be performed by a ranking manager as described with reference to FIGS. 4 through 7.

At 810, the device may monitor, via a sensor, a performance attribute of the first user while the first user plays a game in the game environment. The operations of 810 may be performed according to the methods described herein. In some examples, aspects of the operations of 810 may be performed by a monitoring manager as described with reference to FIGS. 4 through 7.

At 815, the device may modify the ranking of the first user in the game environment based on the monitored performance attribute of the first user. The operations of 815 may be performed according to the methods described herein. In some examples, aspects of the operations of 815 may be performed by a ranking manager as described with reference to FIGS. 4 through 7.

At 820, the device may match the first user with a second user of the set of users based on the modified ranking of the first user. The operations of 820 may be performed according to the methods described herein. In some examples, aspects of the operations of 820 may be performed by a matching manager as described with reference to FIGS. 4 through 7.

FIG. 9 shows a flowchart illustrating a method 900 that supports using sensor statistics for ranking users in matchmaking systems in accordance with aspects of the present disclosure. The operations of method 900 may be implemented by a device or its components as described herein. For example, the operations of method 900 may be performed by a matchmaking manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 905, the device may determine a ranking of a first user of a set of users in a game environment. The operations of 905 may be performed according to the methods described herein. In some examples, aspects of the operations of 905 may be performed by a ranking manager as described with reference to FIGS. 4 through 7.

At 910, the device may monitor, via a sensor, a performance attribute of the first user while the first user plays a game in the game environment. The operations of 910 may be performed according to the methods described herein. In some examples, aspects of the operations of 910 may be performed by a monitoring manager as described with reference to FIGS. 4 through 7.

At 915, the device may modify the ranking of the first user in the game environment based on the monitored performance attribute of the first user. The operations of 915 may be performed according to the methods described herein. In some examples, aspects of the operations of 915 may be performed by a ranking manager as described with reference to FIGS. 4 through 7.

At 920, the device may modify the ranking of the first user in the game environment based on a previous performance attribute of the first user during a previous game. The operations of 920 may be performed according to the methods described herein. In some examples, aspects of the operations of 920 may be performed by a ranking manager as described with reference to FIGS. 4 through 7.

At 925, the device may compare the performance attribute of the first user to a performance attribute threshold, where modifying the ranking of the first user is based on a result of comparing the performance attribute of the first user to the performance attribute threshold. The operations of 925 may be performed according to the methods described herein. In some examples, aspects of the operations of 925 may be performed by an analysis manager as described with reference to FIGS. 4 through 7.

At 930, the device may analyze the performance attribute of the first user using machine learning, where modifying the ranking of the first user is based at least in part on a result of analyzing the performance attribute of the first user using machine learning. The operations of 930 may be performed according to the methods described herein. In some examples, aspects of the operations of 930 may be performed by an analysis manager as described with reference to FIGS. 4 through 7.

At 935, the device may match the first user with a second user of the set of users based on the modified ranking of the first user. The operations of 935 may be performed according to the methods described herein. In some examples, aspects of the operations of 935 may be performed by a matching manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for game matchmaking, comprising:
determining a ranking of a first user of a plurality of users in a game environment;
monitoring, via a sensor, a performance attribute of the first user while the first user plays a game in the game environment;
modifying the ranking of the first user in the game environment based at least in part on the monitored performance attribute of the first user; and
matching the first user with a second user of the plurality of users based at least in part on the modified ranking of the first user.

2. The method of claim 1, further comprising:
modifying the ranking of the first user in the game environment based at least in part on a previous performance attribute of the first user during a previous game.

3. The method of claim 1, further comprising:
comparing the performance attribute of the first user to a performance attribute threshold, wherein modifying the ranking of the first user is based at least in part on a result of comparing the performance attribute of the first user to the performance attribute threshold.

4. The method of claim 1, further comprising:
analyzing the performance attribute of the first user using machine learning, wherein modifying the ranking of the first user is based at least in part on a result of analyzing the performance attribute of the first user using the machine learning.

5. The method of claim 4, wherein analyzing the performance attribute of the first user using the machine learning comprises:
analyzing a match history of the first user using the machine learning, the match history comprising at least one previous match outcome associated with the first user linked with the monitored performance attribute of the first user.

6. The method of claim 4, further comprising:
predicting an outcome of a match between the first user and the second user based at least in part on the result of analyzing the performance attribute of the first user using the machine learning.

7. The method of claim 1, wherein the performance attribute comprises an inertial measurement unit, or an eye movement, or a heart rate, or a controller movement, or a rate of movement, or any combination thereof.

8. The method of claim 1, wherein the sensor comprises an eye tracker, or a heart monitor, or a gyroscope, or a motion sensor, or an infrared sensor, or a biometric sensor, or any combination thereof.

9. The method of claim 1, wherein the sensor is integrated in a smart phone, a game controller, a remote control, a television, a game console, a camera, or any combination thereof.

10. An apparatus for game matchmaking, comprising:
means for determining a ranking of a first user of a plurality of users in a game environment;
means for monitoring, in conjunction with a sensor, a performance attribute of the first user while the first user plays a game in the game environment,
means for modifying the ranking of the first user in the game environment based at least in part on the monitored performance attribute of the first user; and
means for matching the first user with a second user of the plurality of users based at least in part on the modified ranking of the first user.

11. The apparatus of claim 10, further comprising:
means for modifying the ranking of the first user in the game environment based at least in part on a previous performance attribute of the first user during a previous game.

12. The apparatus of claim 10, further comprising:
means for comparing the performance attribute of the first user to a performance attribute threshold, wherein modifying the ranking of the first user is based at least in part on a result of comparing the performance attribute of the first user to the performance attribute threshold.

13. The apparatus of claim 10, further comprising:
means for analyzing the performance attribute of the first user using machine learning, wherein modifying the ranking of the first user is based at least in part on a result of analyzing the performance attribute of the first user using the machine learning.

14. The apparatus of claim 13, wherein the means for analyzing the performance attribute of the first user using the machine learning comprises:
means for analyzing a match history of the first user using the machine learning, the match history comprising at least one previous match outcome associated with the first user linked with the monitored performance attribute of the first user.

15. The apparatus of claim 13, further comprising:
means for predicting an outcome of a match between the first user and the second user based at least in part on the result of analyzing the performance attribute of the first user using the machine learning.

16. The apparatus of claim 10, wherein the performance attribute comprises an inertial measurement unit, or an eye movement, or a heart rate, or a controller movement, or a rate of movement, or any combination thereof.

17. The apparatus of claim 10, wherein the sensor comprises an eye tracker, or a heart monitor, or a gyroscope, or a motion sensor, or an infrared sensor, or a biometric sensor, or any combination thereof.

18. The apparatus of claim 10, wherein the sensor is integrated in a smart phone, a game controller, a remote control, a television, a game console, a camera, or any combination thereof.

19. A non-transitory computer-readable medium storing code for game matchmaking, the code comprising instructions executable by a processor to:
determine a ranking of a first user of a plurality of users in a game environment;
monitor, in conjunction with a sensor, a performance attribute of the first user while the first user plays a game in the game environment;
modify the ranking of the first user in the game environment based at least in part on the monitored performance attribute of the first user; and
match the first user with a second user of the plurality of users based at least in part on the modified ranking of the first user.

20. The non-transitory computer-readable medium of claim 19, wherein the instructions are further executable to:
modify the ranking of the first user in the game environment based at least in part on a previous performance attribute of the first user during a previous game.
